(19) United States
(12) Patent Application Publication
(10) Pub. No.: US 2026/0124905 A1
(43) Pub. Date: May 7, 2026

(54) COOLING SYSTEM AND VEHICLE

(71) Applicant: Isuzu Motors Limited, Yokohama-shi (JP)

(72) Inventor: Hitoshi AIZONO, Fujisawa-shi (JP)

(73) Assignee: Isuzu Motors Limited, Yokohama-shi (JP)

(21) Appl. No.: 19/355,859

(22) Filed: Oct. 10, 2025

(30) Foreign Application Priority Data
Nov. 6, 2024 (JP) 2024-194264

(51) Int. Cl. B60K 11/04; B60K 11/08

(52) U.S. Cl. CPC B60K 11/04; B60K 11/08

(57) ABSTRACT

A cooling system for a coolant, includes: a radiator with a core part; a fan section; a shutter section; a first temperature sensor configured to detect a temperature of the coolant; and a controller configured to, based on the first detection temperature detected by the first temperature sensor. The controller is configured to switch between: a first mode in which, when the first detection temperature is a first temperature or below, the controller rotates a first fan and stops rotation of a second fan in a state that the controller opens a first shutter and closes a second shutter; and a second mode in which, when the first detection temperature is a second temperature or below, the second temperature being greater than the first temperature, the controller rotates the first and second fans in a state that the controller opens the first and second shutters.

### CROSS REFERENCE TO RELATED APPLICATIONS

This application is based upon and claims the benefit of priority from prior Japanese Patent Application No. 2024-194264, filed November 6, 2024, the entire contents of which are incorporated herein by reference.

### FIELD

The present invention relates to a cooling system and a vehicle.

### BACKGROUND

A coolant cooling apparatus is disclosed in, for example, Jpn. Pat. Appln. KOKAI Publication No. 2018-043554, in which a plurality of fans disposed at the back of a radiator are simultaneously rotated to forcibly cool a suitably wide area of a core part (radiator core) of the radiator, thereby cooling a coolant (cooling fluid).

In the case of using such a cooling system in which a plurality of fans are simultaneously rotated at the same rotational frequency, there may be a difference in rotational frequency or wind velocity between the fans.

### SUMMARY

According to an aspect of the invention, a cooling system for a coolant, includes: a radiator including a core part through which air is provided from a front surface side to a back surface side, the core part being virtually partitioned into a first region and a second region along a flow direction in which a coolant is flown, the first region being on a side closer to an upstream side and functioning as an inlet of the coolant which has passed through a heat source, the second region being on a side closer to a downstream side than the upstream side and functioning as an outlet of the coolant; a fan section provided on the back surface side of the core part, the fan section including a first fan facing the first region and a second fan facing the second region; a shutter section provided on the front surface side or the back surface side of the core part, or a rear side of the fan section, the shutter section including: a first shutter facing the first region and configured to be opened and closed for the first region, a second shutter facing the second region and configured to be opened and closed for the second region; a fan shroud surrounding an outer periphery of the first fan and an outer periphery of the second fan at the back surface side of the core part, and partitioning the first region and the second region at the back surface side of the core part; a first temperature sensor configured to detect, as a first detection temperature, a temperature of the coolant at a predetermined position on a side closer to the outlet of the coolant; and a controller configured to, based on the first detection temperature detected by the first temperature sensor, independently control the first fan and the second fan of the fan section, and independently control the first shutter and the second shutter of the shutter section. The controller is configured to switch between: a first mode in which, when the first detection temperature is a first temperature or below, the controller is configured to rotate the first fan and stop rotation of the second fan in a state that the controller is configured to open the first shutter and close the second shutter; and a second mode in which, when the first detection temperature is a second temperature or below, the second temperature being greater than the first temperature, the controller is configured to rotate the first fan and the second fan in a state that the controller is configured to open the first shutter and the second shutter.

### BRIEF DESCRIPTION OF THE DRAWINGS

FIG. 1 is a schematic diagram showing a part of a front section of a vehicle according to a first embodiment.

FIG. 2 is a schematic diagram showing a cooling apparatus as viewed from a direction along line II-II of FIG. 1.

FIG. 3 is a schematic block diagram related to cooling of a heat source of the vehicle according to the first embodiment.

FIG. 4 is a flowchart related to a coolant cooling process using a cooling apparatus according to the first embodiment.

FIG. 5 is a schematic block diagram related to cooling of a heat source of a vehicle according to a first modification of the first embodiment.

FIG. 6 is a flowchart related to a coolant cooling process using a cooling apparatus shown in FIG. 5.

FIG. 7 is a schematic diagram showing a part of a front section of a vehicle according to a second modification of the first embodiment.

FIG. 8 is a schematic diagram showing a part of a front section of a vehicle according to a second embodiment.

FIG. 9 is a schematic diagram showing a part of a front section of a vehicle according to a third embodiment.

FIG. 10 is a schematic diagram showing a part of a front section of a vehicle according to a fourth embodiment.

### DETAILED DESCRIPTION

A vehicle 10 including a cooling system 22 for cooling a coolant (a cooling fluid) which has passed through a heat source 12 will be described with reference to the accompanying drawings.

### First Embodiment

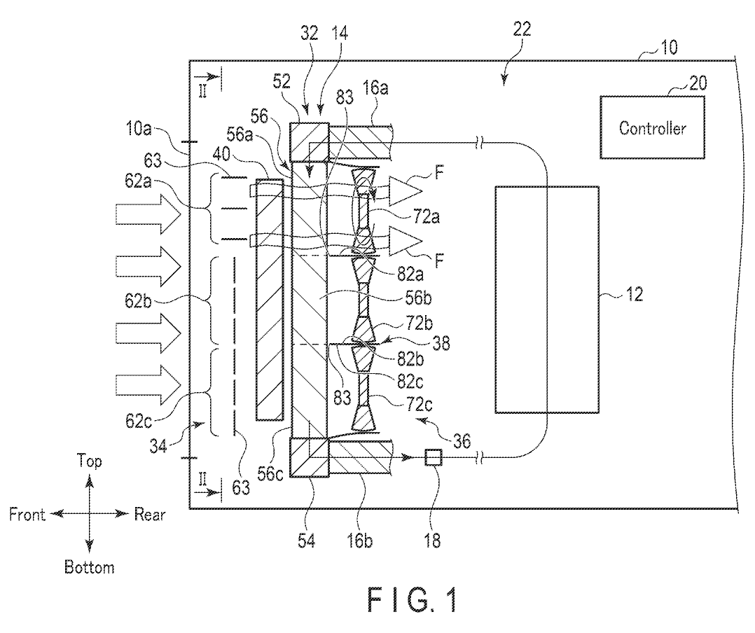

A vehicle 10 including a cooling system 22 for a coolant (cooling fluid) according to a first embodiment will be described with reference to FIGS. 1 to 4.

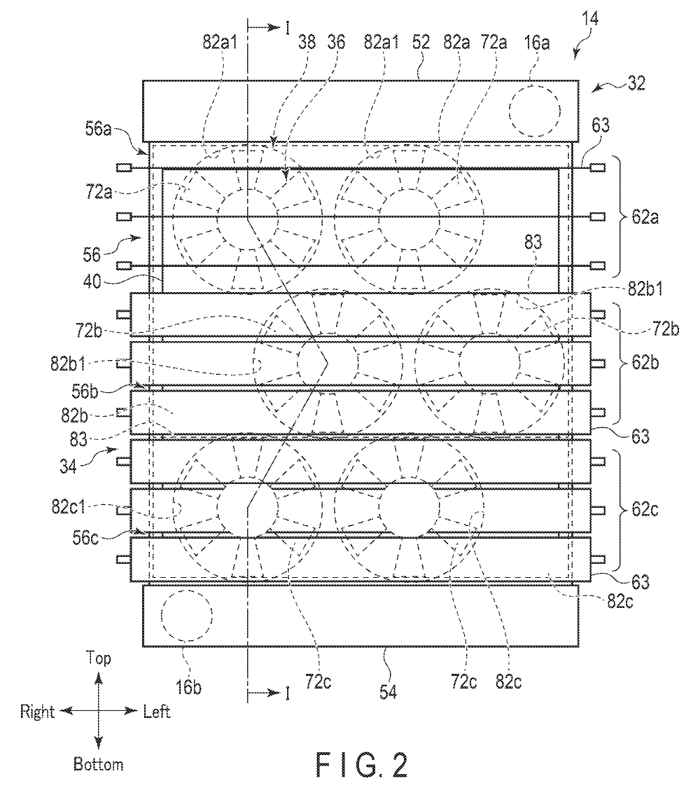

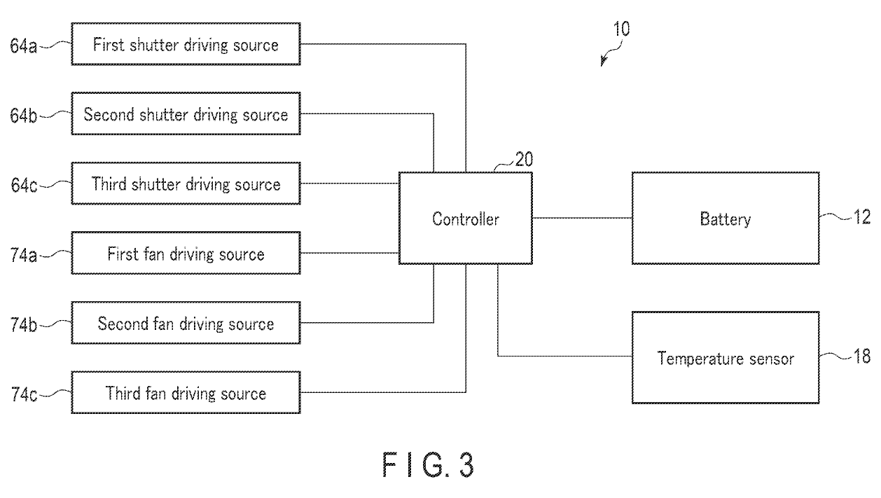

FIG. 1 is a schematic diagram showing a part of a front section of the vehicle 10 according to the first embodiment. FIG. 2 is a schematic diagram showing a cooling apparatus 14 as viewed from a direction along line II-II of FIG. 1. Note that the cooling apparatus 14 in FIG. 1 is shown as a cross-sectional diagram along line I-I in FIG. 2. FIG. 3 is a schematic block diagram related to an apparatus for cooling a heat source 12 of the vehicle 10 according to the first embodiment.

A front side, a rear side, a top side, and a bottom side of the vehicle 10 are taken as shown in FIG. 1. As shown in FIG. 1, the vehicle 10 includes a grille 10a at the front side. The grille 10a is provided in, for example, a body of the vehicle 10, and is used as an intake port of the air F into the body during traveling, etc., of the vehicle 10.

The vehicle 10 includes a heat source 12, a cooling apparatus 14 for a coolant which has passed through the heat source 12, flow paths 16a and 16b for allowing the coolant to be circulated through the heat source 12 and a radiator 32, to be described below, of the cooling apparatus 14, a temperature sensor 18 for measuring a temperature of the coolant, and a controller 20. The cooling apparatus 14, the flow paths 16a and 16b, the temperature sensor 18, and the controller 20 are used as a cooling system 22 for cooling a coolant that passes through the heat source 12.

Examples of the heat source 12 include an engine as a power source, a motor as a power source, and a battery for supplying motor driving power, and the like. In the vehicle 10 according to the present embodiment, the heat source 12 will be described as a battery; however, the heat source 12 may be either an engine, a motor, or the like. Examples of the vehicle 10 include the so-called engine vehicle, an electric vehicle (EV), a hybrid electric vehicle (HEV), a plug-in hybrid electric vehicle (PHEV), and a fuel cell electric vehicle (FCEV).

The cooling apparatus 14 is provided at the rear of the grille 10a of the vehicle 10 at a position where a headwind (wind during traveling) blows through the grille 10a during traveling of the vehicle 10.

The cooling apparatus 14 includes a radiator 32, a shutter section 34, a fan section 36, and a fan shroud (fan guide) 38.

Note that FIG. 1 shows an example in which a condenser 40 is provided at a front surface side of the radiator 32. The condenser 40 includes multiple communicating portions in the front-rear direction to allow the headwind (wind during traveling) to be blown into the radiator 32. The condenser 40 may be arranged on the top side, the bottom side, the left side, or the right side of the radiator 32, instead of the front surface side of the radiator 32.

The radiator 32 is a heat exchanger adapted to cool a coolant that has passed through the heat source 12 using air (outside air) F supplied through the grille 10a of the vehicle 10. It is assumed that the radiator 32 according to the present embodiment is a downflow radiator adapted to flow a coolant from top to bottom. The flow path 16a is connected to a coolant outlet from the heat source 12, and to a coolant inlet to the radiator 32. Also, the flow path 16b is connected to a coolant inlet to the heat source 12, and is connected to a coolant outlet from the radiator 32. Thus, the coolant flowing through the flow path 16a on the upstream side, as viewed from the radiator 32, has a higher temperature than the coolant flowing through the flow path 16b on the downstream side.

The radiator 32 includes an upper tank 52, a lower tank 54, and a core part 56 between the upper tank 52 and the lower tank 54.

The upper tank 52 is provided at the coolant inlet to the radiator 32, namely, at a connection part between the flow path 16a and the radiator 32. The lower tank 54 is provided at the coolant outlet from the radiator 32, namely, at a connection part between the flow path 16b and the radiator 32.

In outer appearance, the core part 56 is formed in, for example, a substantially parallelepiped shape. The core part 56 allows air (outside air) F supplied through the grille 10a to flow from a front surface side to a back surface side, and gradually cools, through heat exchange, a coolant that has passed through the heat source 12 and flows from the upstream side of the core part 56 as a hot fluid with a temperature that needs to be cooled as the coolant travels downstream. It is assumed in the present embodiment that the core part 56 is virtually partitioned into a first region (hereinafter mainly referred to as a “top tier”) 56a on the top side closer to the upper tank 52 (closer to the upstream side along the coolant flowing direction), a second region (hereinafter mainly referred to as a “middle tier”) 56b therebelow, and a third region (hereinafter mainly referred to as a “bottom tier”) 56c on the bottom side (closer to the downstream side along the coolant flowing direction) closer to the lower tank 54. Note that, in the core part 56, the top tier 56a and the middle tier 56b are continuous, not disconnected, and that the middle tier 56b and the bottom tier 56c are continuous, not disconnected. In this manner, in the present embodiment, the core part 56 is virtually partitioned along the coolant flowing direction into three: the top tier 56a; the middle tier 56b; and the bottom tier 56c. The top tier 56a, the middle tier 56b, and the bottom tier 56c of the core part 56 are formed in, for example, a rectangular shape of the same size both in the plane of the front surface and in the plane of the back surface of the core part 56.

The shutter section 34 is provided on the front surface side of the radiator 32 and on a front surface side of the condenser 40. The shutter section 34 is capable of permitting and/or shielding a flow of the air F to the radiator 32 taken in through the grille 10a. The shutter section 34 includes a first shutter 62a facing the top tier 56a of the core part 56, a second shutter 62b facing the middle tier 56b of the core part 56, and a third shutter 62c facing the bottom tier 56c of the core part 56.

Each of the shutters 62a, 62b, and 62c is configured of, for example, one or more movable bodies 63 that extend in a right-left direction. The movable bodies 63 are, for example, rectangular plates. Each plate 63 is defined by a longer side, a shorter side, and a height (a thickness). The longer side is greater than the shorter side. The shorter side is greater than the height (thickness). The plates 63 are supported at their end portions in the right-left direction, and can be opened and closed by pivoting. The length of each plate 63 in the right-left direction is set in such a manner that the front surface of the core part 56 can be covered in the right-left direction.

The first shutter 62a, the second shutter 62b, and the third shutter 62c can be independently opened and closed. On the other hand, the three plates 63 of the first shutter 62a can be opened and closed in conjunction with one another. Similarly, the three plates 63 of each of the second shutter 62b and the third shutter 62c can be opened and closed in conjunction with one another. Note that, in FIGS. 1 and 2, the first shutter 62a is in an open state, and the second shutter 62b and the third shutter 62c are in a closed state.

It is preferable that a gap between the adjacent shutters 62a and 62b in a closed state and a gap between the adjacent shutters 62b and 62c in a closed state be designed to be small to prevent or suppress passing of the air F therethrough. The adjacent shutters 62a and 62b in a closed state may partially overlap each other without a gap; similarly, the adjacent shutters 62b and 62c in a closed state may partially overlap each other without a gap.

The shutter section 34 includes a first shutter driving source 64a adapted to open and close the first shutter 62a, the second shutter driving source 64b adapted to open and close the second shutter 62b, and the third shutter driving source 64c adapted to open and close the third shutter 62c. These shutter driving sources 64a, 64b, and 64c are formed using, for example, a motor or a solenoid, and are driven using, for example, power from a battery 12.

The fan section 36 is provided on the back surface side of the core part 56. The fan section 36 is provided for forced ventilation from the front surface side to the back surface side of the core part 56. The fan section 36 includes one or more first fans 72a facing the top tier 56a of the core part 56, one or more second fans 72b facing the middle tier 56b of the core part 56, and one or more third fans 72c facing the bottom tier 56c of the core part 56. It is preferable that the fans 72a, 72b, and 72c be of the same type. In the present embodiment, two fans 72a, two fans 72b, and two fans 72c are arranged side by side so as to respectively face the tiers 56a, 56b, and 56c.

The fan section 36 includes a first fan driving source 74a adapted to rotate the first fans 72a, a second fan driving source 74b adapted to rotate the second fans 72b, and a third fan driving source 74c adapted to rotate the third fans 72c. These fan driving sources 74a, 74b, and 74c are formed using, for example, a motor, and are driven using, for example, power from the battery 12.

The first fans 72a, the second fans 72b, and the third fans 72c are capable of independently controlling rotation and cessation of rotation. The two first fans 72a may operate at the same rotational frequency. Similarly, the two second fans 72b may operate at the same rotational frequency, and the two third fans 72c may operate at the same rotational frequency.

The fan shroud 38 covers the entire back surface side of the core part 56, and covers an outer region of each of the fans 72a, 72b, and 72c. The fan shroud 38 partitions the top tier 56a and the middle tier 56b and partitions the middle tier 56b and the bottom tier 56c at the back surface of the core part 56 to prevent or interrupt an airflow between the top tier 56a and the middle tier 56b and between the middle tier 56b and the bottom tier 56c at the back surface of the core part 56.

In the present embodiment, the fan shroud 38 includes a first cylindrical portion 82a in a cylindrical shape extending along an outer edge of a back surface of the top tier 56a of the core part 56 or its neighborhood, and the first cylindrical portion 82a includes two annular portions 82a1 respectively surrounding outer peripheries of the two first fans 72a. Similarly, the fan shroud 38 includes a second cylindrical portion 82b in a cylindrical shape extending along an outer edge of a back surface of the middle tier 56b of the core part 56 or its neighborhood and including two annular portions 82b1 respectively surrounding outer peripheries of the two second fans 72b; furthermore, the fan shroud 38 includes a third cylindrical portion 82c in a cylindrical shape extending along an outer edge of a back surface of the bottom tier 56c of the core part 56 or its neighborhood and including two annular portions 82c1 respectively surrounding outer peripheries of the two third fans 72c. In each of the cylindrical portions 82a, 82b, and 82c, the two fans 72a, the two fans 72b, and the two fans 72c, respectively surrounded by the corresponding two annular portions 82a1, 82b1, and 82c1, are arranged side by side. Note that the three cylindrical portions 82a, 82b, and 82c are, for example, integrally formed.

Also note that each of the cylindrical portions 82a, 82b, and 82c of the fan shroud 38 includes an end face 83 brought in contact with or in proximity to the back surface of the core part 56. The fan shroud 38 interrupts or prevents an airflow between the cylindrical portions 82a and 82b via the end faces 83, and an airflow between the cylindrical portions 82b and 82c via the end faces 83, regardless of whether or not the fans 72a, 72b, and 72c are rotating at the back surface of the core part 56.

The two fans 72a, the two fans 72b, and the two fans 72c are, for example, distanced at the same interval in the right-left direction. The pair of first fans 72a is deviated from the center toward the right in the right-left direction at the back surface side of the top tier 56a of the core part 56. The pair of second fans 72b is deviated from the center toward the left at the back surface side of the middle tier 56b of the core part 56. The pair of third fans 72c is deviated from the center toward the right at the back surface side of the bottom tier 56c of the core part 56. The right second fan 72b of the pair of second fans 72b is disposed below the space between the pair of first fans 72a, and above the space between the pair of third fans 72c. This allows the cooling apparatus 14 to use the fans 72a, 72b, and 72c with larger diameters, without the pairs of fans 72a and 72b and the pairs of fans 72b and 72c interfering with each other. By thus disposing the central axes of the fans 72a, 72b, and 72c in a zig-zag pattern, as shown in FIG. 2, it is possible to adopt the fans 72a, 72b, and 72c with larger diameters, compared to the case where the fans 72a, 72b, and 72c are merely arranged in a vertically straight line.

The temperature sensor 18 is controlled by the controller 20, and is adapted to be able to detect, as a first detection temperature, a temperature of a coolant at a predetermined position on a side closer to the coolant outlet from the radiator 32.

It is preferable that the controller 20 be formed as one or more vehicle-mounted electric control units (ECUs). The controller 20 is configured of a computer, etc., and includes a processor (processing unit) and a storage medium. The controller 20 is adapted to execute programs stored in the storage medium, etc., thereby executing suitable processes based on a flow to be described below. Also, the programs executed by the controller 20 may be stored in a computer (server) connected to the controller 20 via a network such as the Internet, etc., or a server in a cloud environment. In this case, the controller 20 downloads the programs via a network, and executes processes in accordance with the programs.

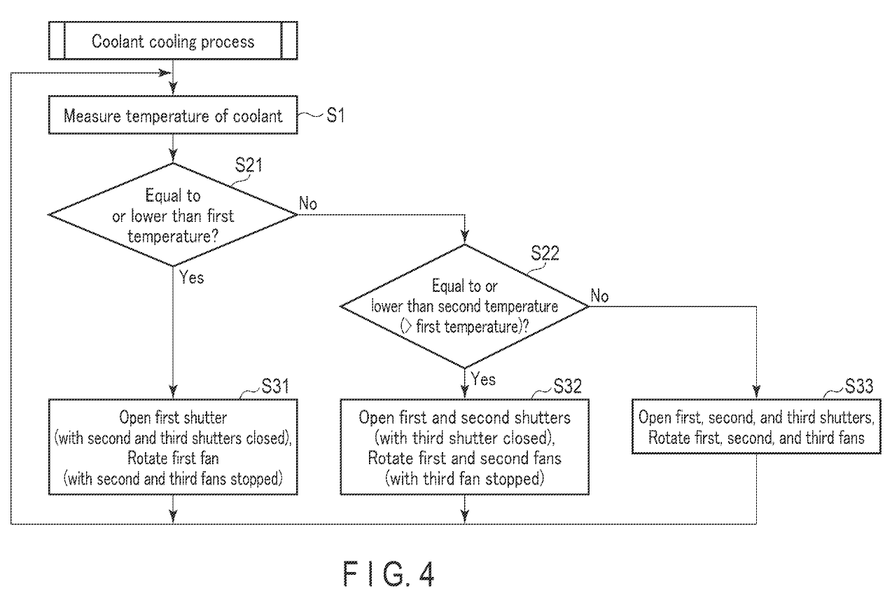

FIG. 4 is a flowchart related to a coolant cooling process using the cooling system 22 according to the first embodiment. The coolant cooling process using the cooling system 22 will be described with reference to the flow shown in FIG. 4.

It is assumed herein that the first shutter 62a is in a closed state during parking of the vehicle 10, although the first shutter 62a may be constantly open.

It is assumed, prior to the start of the coolant cooling process, that the vehicle 10 is parked, that circulation of the coolant through the radiator 32, the heat source 12, and the flow paths 16a and 16b has stopped, that the shutters 62a, 62b, and 62c are in a closed state, and that rotation of the fans 72a, 72b, and 72c has stopped.

Upon switching of the vehicle 10 from a parked state to a ready-to-travel state (including a standing state), the coolant is circulated through the radiator 32, the heat source 12, and the flow paths 16a and 16b by an unillustrated pump, and the controller 20 starts a coolant cooling process using the radiator 32. The coolant cooling process using the radiator 32 by the controller 20 is repeatedly performed until the vehicle 10 is brought from the ready-to-travel state to the parked state, or until a detection temperature at the temperature sensor 18 reaches a predetermined temperature or below after the vehicle 10 is brought to the parked state. It is assumed herein that the predetermined temperature is a temperature T0 lower than a 1a-th temperature T1a, to be described below.

As described above, upon switching of the vehicle 10 from the parked state to the ready-to-travel state, the controller 20 controls the temperature sensor 18 to measure (detect) a temperature in the vicinity of the coolant outlet from the radiator 32 (step S1).

The controller 20 determines whether the measurement temperature (detection temperature) by the temperature sensor 18 is equal to or lower than the 1a-th temperature T1a (step S21). When the measurement temperature is equal to or lower than the 1a-th temperature T1a (step S21-Yes), the controller 20 controls the shutter driving sources 64a, 64b, and 64c using power from the battery 12 to open the first shutter 62a and to maintain the second shutter 62b and the third shutter 62c in a closed state. Also, the controller 20 controls the fan driving sources 74a, 74b, and 74c using power from the battery 12 to rotate the first fans 72a. The controller 20 maintains the rotation stopped state of the second fans 72b and the third fans 72c (step S31). Such a mode will be referred to as a “first mode”.

In the first mode, air F is taken into the vehicle 10 through the grille 10a by rotation of the first fans 72a in the first cylindrical portion 82a. The air F taken into the vehicle 10 passes through the top tier 56a of the core part 56 through the first shutter 62a, where the air F is raised to a high temperature through heat exchange, compared to the time of passing through the grille 10a, and is ejected to the rear of the first cylindrical portion 82a through the first cylindrical portion 82a. Thus, the air on the back surface side of the core part 56, namely, the air on the back surface side of the core part 56 that has passed through the first cylindrical portion 82a, has a higher temperature and a higher voltage than the air between the grille 10a and the core part 56. In other words, the air between the grille 10a and the core part 56 has a lower temperature and a lower voltage than the air on the back surface side of the core part 56.

Assuming that all the shutters 62a, 62b, and 62c are in an open state, a temperature difference between the upstream-side coolant passing through the heat source 12 and the top tier 56a of the core part 56 and the air passing through the top tier 56a of the core part 56 is larger than a temperature difference between the downstream-side coolant passing through the bottom tier 56c of the core part 56 and the air passing through the bottom tier 56c of the core part 56. Thus, in the first mode in which the fans 72a are rotated with the shutter 62a facing the top tier 56a opened and the shutters 62a and 62c closed to allow the air F taken into the vehicle 10 through the grille 10a to be blown into the top tier 56a of the core part 56, the effect of lowering the temperature of the coolant increases, compared to the case where, for example, rotation of the fans 72a is stopped with the shutter 62a closed and the fans 72b and 72c are rotated with the shutters 62b and 62c opened to allow the air F taken into the vehicle 10 through the grille 10a to be blown into the middle tier 56b or the bottom tier 56c of the core part 56.

Accordingly, by opening the shutter 62a facing the top tier 56a on the upstream side along the coolant flowing direction of the core part 56 to actively whirl the fans 72a facing the top tier 56a, in order to allow the air F to be blown into the top tier 56a, as in the first mode, it is possible to further enhance the cooling effect (heat radiation effect) of the coolant. Also, since the fans 72b and 72c need not be moved in the case where the controller 20 controls the cooling apparatus 14 as in the first mode, it is possible to enhance the power efficiency of the battery 12, namely, to suppress the power consumption of the battery 12.

In general, air flows from a higher pressure side to a lower pressure side. In the first mode, the second shutter 62b and the third shutter 62c are closed. However, the fan shroud 38 partitions the top tier 56a and the middle tier 56b and partitions the middle tier 56b and the bottom tier 56c at the back surface of the core part 56 to prevent an airflow between the first cylindrical portion 82a and the second cylindrical portion 82b and between the second cylindrical portion 82b and the third cylindrical portion 82c at the back surface of the core part 56. With such a configuration, the cooling apparatus 14 is capable of suppressing an airflow that interferes with the flow of the air F taken in from the grille 10a, namely, air flowing from the second cylindrical portion 82b to the first cylindrical portion 82a at the back surface of the core part 56 and air flowing from the third cylindrical portion 82c to the second cylindrical portion 82b. It is thereby possible to make the cooling efficiency of the coolant favorable in the case of releasing, for example, only the shutter 62a facing the top tier 56a on the upstream side of the core part 56, and rotating only the fans 72a.

Accordingly, with the cooling system 22 performing a cooling process in the first mode, it is possible to make the cooling efficiency of the coolant flowing through the core part 56 of the radiator 32 favorable.

By the first-mode processing at step S31, the controller 20 performs the processing at step S1 again, while rotating the first fans 72a at a suitable rotational frequency with the first shutter 62a opened.

When, for example, the measurement temperature by the temperature sensor 18 is not equal to or lower than the 1a-th temperature T1a (step S21-No), the controller 20 determines whether the measurement temperature is equal to or lower than a 2a-th temperature T2a (step S22). Note that the following relationship is satisfied: 2a-th temperature T2a > 1a-th temperature T1a. When the measurement temperature is equal to or lower than the 2a-th temperature T2a (step S22-Yes), the controller 20 controls the shutter driving sources 64a, 64b, and 64c using the power from the battery 12 to open the second shutter 62b with the first shutter 62a maintained in an open state and the third shutter 62c maintained in a closed state. Also, the controller 20 controls the fan driving sources 74a, 74b, and 74c using the power from the battery 12 to rotate the second fans 72b, with the first fans 72a maintained in a rotating state. The controller 20 maintains the rotation stopped state of the third fans 72c (step S32). Note that the first fans 72a and the second fans 72b are set to have an identical or substantially identical rotational frequency, or the second fans 72b are set to have a lower rotational frequency than the first fans 72a. Such a mode will be referred to as a “second mode”.

As described above, in the case where the coolant is cooled on the upstream side of the core part 56, the effect of lowering the temperature of the coolant increases, compared to the case where the coolant is cooled on the downstream side of the core part 56. Accordingly, by opening the shutters 62a and 62b respectively facing the top tier 56a and the middle tier 56b on the upstream side of the core part 56 along the coolant flowing direction to actively whirl the fans 72a and 72b respectively facing the top tier 56a and the middle tier 56b, thus allowing the air F to be blown into the top tier 56a and the middle tier 56b, as in the second mode, it is possible to further enhance the coolant cooling effect. With the controller 20 adapted to control the cooling apparatus 14 as in the second mode, it is possible to eliminate the need to move the fans 72c, thus enhancing the power efficiency of the battery 12.

Also, in the second mode, the fan shroud 38 prevents not only an airflow between the first cylindrical portion 82a and the second cylindrical portion 82b but also an airflow between the second cylindrical portion 82b and the third cylindrical portion 82c at the back surface of the core part 56. With such a configuration, the cooling apparatus 14 is capable of suppressing an airflow that interferes with the flow of the air F taken in from the grille 10a, namely, air flowing from the second cylindrical portion 82b to the first cylindrical portion 82a and air flowing from the third cylindrical portion 82c to the second cylindrical portion 82b at the back surface of the core part 56. It is thereby possible to make the cooling efficiency of the coolant favorable in the case of, for example, releasing only the shutters 62a and 62b respectively facing the top tier 56a and the middle tier 56b on the upstream side of the core part 56, and rotating only the fans 72a and 72b.

By allowing the fans 72a on the side of the top tier 56a closer to the upstream side as viewed from the radiator 32 to have a higher rotational frequency, it is possible to effectively lower the temperature of the coolant, thus allowing the coolant to circulate through the middle tier 56b and the bottom tier 56c. On the other hand, when a difference in wind velocity occurs in the air that has passed through the core part 56, the air flows from a higher pressure side to a lower pressure side. In this case, since part of the air interferes with the airflow from the front surface side to the back surface side of the core part 56, the cooling efficiency may decrease. In the present embodiment, the fan shroud 38 prevents an airflow between the first cylindrical portion 82a and the second cylindrical portion 82b at the back surface of the core part 56. It is thus possible to prevent the occurrence of a cooling efficiency reducing phenomenon in which air flows from a higher pressure side to a lower pressure side even when a difference in rotational frequency is provided between the first fans 72a and the second fans 72b. With the use of the fan shroud 38 adapted to partition the top tier 56a and the middle tier 56b and to partition the middle tier 56b and the bottom tier 56c at the back surface of the core part 56, thus preventing an airflow between the first cylindrical portion 82a and the second cylindrical portion 82b and between the second cylindrical portion 82b and the third cylindrical portion 82c, it is possible to make the cooling efficiency of the coolant favorable even when a difference in rotational frequency is provided between the fans 72a and 72b or even when a difference in wind velocity occurs due to the individual difference between the fans 72a and 72b.

Accordingly, with the cooling system 22 performing a cooling process in the second mode, it is possible to make the cooling efficiency of the coolant flowing through the core part 56 of the radiator 32 favorable.

By the second-mode processing at step S32, the controller 20 performs the processing at step S1 again, while rotating the first fans 72a and the second fans 72b at a suitable rotational frequency with the first shutter 62a and the second shutter 62b opened.

When, for example, the measurement temperature is not equal to or lower than the 2a-th temperature T2a (step S22-No), namely, when it exceeds the 2a-th temperature T2a, the controller 20 controls the shutter driving sources 64a, 64b, and 64c using the power from the battery 12 to open the third shutter 62c with the first shutter 62a and the second shutter 62b maintained in an open state. Also, the controller 20 controls the fan driving sources 74a, 74b, and 74c using the power from the battery 12 to maintain the first fans 72a and the second fans 72b in a rotating state, and controls the third fan driving source 74c to rotate the third fans 72c (step S33). Note that the first fans 72a, the second fans 72b, and the third fans 72c are set to have an identical or substantially identical rotational frequency; alternatively, the second fans 72b are set to have a lower rotational frequency than the first fans 72a, and the third fans 72c are set to have a lower rotational frequency than the second fans 72b. Such a mode will be referred to as a “third mode”.

By opening all the shutters 62a, 62b, and 62c to actively whirl the fans 72a, 72b, and 72c facing the top tier 56a, the middle tier 56b, and the bottom tier 56c, respectively, in order to allow the air F to be blown into the top tier 56a, the middle tier 56b, and the bottom tier 56c, it is possible to further enhance the coolant cooling effect.

In the third mode, all the fans 72a, 72b, and 72c are rotated, with all the shutters 62a, 62b, and 62c opened. Also, the fan shroud 38 prevents not only an airflow between the first cylindrical portion 82a and the second cylindrical portion 82b but also an airflow between the second cylindrical portion 82b and the third cylindrical portion 82c at the back surface of the core part 56. With such a configuration, the cooling apparatus 14 is capable of suppressing an airflow that interferes with the flow of the air F taken in from the grille 10a, namely, air flowing from the second cylindrical portion 82b to the first cylindrical portion 82a and air flowing from the third cylindrical portion 82c to the second cylindrical portion 82b at the back surface of the core part 56. It is thereby possible to make the cooling efficiency of the coolant favorable in the case of rotating all the fans 72a, 72b, and 72c with all the shutters 62a, 62b, and 62c opened.

Accordingly, with the cooling system 22 performing a cooling process in the third mode, it is possible to make the cooling efficiency of the coolant flowing through the core part 56 of the radiator 32 favorable.

By the third-mode processing at step S33, the controller 20 performs the processing at step S1 again, while rotating the first fans 72a, the second fans 72b, and the third fans 72c at a suitable rotational frequency with the first shutter 62a, the second shutter 62b, and the third shutter 62c opened.

Accordingly, the controller 20 repeats the coolant cooling process by switching between the first mode, the second mode, and the third mode based on the temperature of the coolant detected by the temperature sensor 18 in accordance with the flow shown in FIG. 4

The coolant cooling process by the controller 20 using the radiator 32 is repeatedly performed until the vehicle 10 is brought to the parked state, or until the detection temperature at the temperature sensor 18 reaches a predetermined temperature T0 or below after the vehicle 10 is brought to the parked state. The controller 20 switches the shutter section 34 and the fan section 36 to one of the first mode, the second mode, or the third mode.

In this manner, the cooling system 22 is configured, based on a temperature in the vicinity of the coolant outlet from the radiator 32, to release, for example, only the shutter 62a facing the top tier 56a on the upstream side of the core part 56 and to rotate only the fans 72a, and it is thereby possible to suitably cool the coolant while improving the power efficiency, compared to the case of releasing all the shutters 62a, 62b, and 62c and rotating all the fans 72a, 72b, and 72c. At this time, by bringing the end faces 83 of the cylindrical portions 82a, 82b, and 82c of the fan shroud 38 in contact with or in proximity to the back surface of the core part 56, it is possible to suppress an airflow that interferes with the flow of the air F taken in from the grille 10a at the back surface of the core part 56. It is thereby possible to make the cooling efficiency favorable in the case of releasing, for example, only the shutter 62a facing the top tier 56a on the upstream side of the core part 56, and rotating only the fans 72a.

In the case of forced cooling with the fans 72a, 72b, and 72c, the cooling efficiency (heat radiation efficiency) increases as the temperature difference between the coolant and the air F blown into the core part 56 increases, and the cooling efficiency decreases as the temperature difference decreases. Thus, in an area closer to the top tier 56a, the temperature difference between the coolant and the air F blown into the core part 56 increases, and the cooling effect increases. Also, in the case of using the fans 72a, 72b, and 72c, which use electric power, a highest power efficiency effect is obtained when rotation is performed with a largest possible temperature difference between the coolant and the air F blown into the core part 56. Accordingly, with the cooling system 22 according to the present embodiment, it is possible to perform efficient cooling by cooling the top tier 56a of the core part 56 first, thus making the cooling efficiency including the power efficiency favorable.

With the cooling system 22 configured, when the temperature of the coolant does not fall to the 1a-th temperature T1a or below only by cooling of the top tier 56a, then the middle tier 56b is cooled in addition to the top tier 56a, and when the temperature of the coolant does not fall to the 2a-th temperature T2a or below only by cooling of the top tier 56a and the middle tier 56b, then the bottom tier 56c is cooled in addition to the top tier 56a and the middle tier 56b, and it is thereby possible to perform efficient cooling, thus making the cooling efficiency including the power efficiency favorable.

Also, by allowing the fans 72a on the side of the top tier 56a closer to the upstream side as viewed from the radiator 32 to have a higher rotational frequency, it is possible to effectively lower the temperature of the coolant, thus allowing the coolant to circulate through the middle tier 56b and the bottom tier 56c. At this time, a fan shroud 38 adapted to partition the top tier 56a and the middle tier 56b and to partition the middle tier 56b and the bottom tier 56c at the back surface of the core part 56 to prevent an airflow between the first cylindrical portion 82a and the second cylindrical portion 82b and between the second cylindrical portion 82b and the third cylindrical portion 82c at the back surface of the core part 56 is used. Through the use of the fan shroud 38 according to the present embodiment, it is possible to suppress an airflow that interferes with the flow of the air F taken in from the grille 10a, namely, air flowing from the second cylindrical portion 82b to the first cylindrical portion 82a at the back surface of the core part 56 and air flowing from the third cylindrical portion 82c to the second cylindrical portion 82b. Accordingly, through the use of the cooling system 22 according to the present embodiment, it is possible to make the cooling efficiency of the coolant flowing through the core part 56 of the radiator 32 favorable.

In the present embodiment, it is possible to provide a cooling system 22 and a vehicle 10 including the cooling system 22 capable of making the cooling efficiency of the coolant flowing through the core part 56 of the radiator 32 favorable.

In the present embodiment, an example has been described in which the first fan driving source 74a is driven using power from the battery 12 to rotate the first fans 72a. The first fans 72a may be rotated using, for example, a crankshaft rotational motion of an engine as the heat source 12.

In the present embodiment, the core part 56 of the radiator 32 is virtually partitioned into three: the top tier 56a; the middle tier 56b; and the bottom tier 56c. The core part 56 of the radiator 32 may be virtually partitioned into, for example, a top tier and a bottom tier, or may be further partitioned into four or more. It is preferable that the numbers of the shutter sections 34, the fan sections 36, and the fan shrouds 38 be defined to correspond to the number of virtual partitions of the core part 56.

In the present embodiment, an example has been described in which two fans 72a, 72b, and 72c are disposed for each of the tiers 56a, 56b, and 56c. For each tier 56a, 56b, and 56c, a single fan 72a, 72b, and 72c may be disposed, or three or more fans 72a, 72b, and 72c may be disposed.

FIG. 1 shows an example in which the grille 10a, the shutter section 34, the radiator 32, and the fan section 36 are aligned on a straight line along the front-rear direction of the vehicle 10. The grille 10a, the shutter section 34, the radiator 32, and the fan section 36 may not be disposed on a straight line, as long as they are along the flow of the air F.

### First Modification

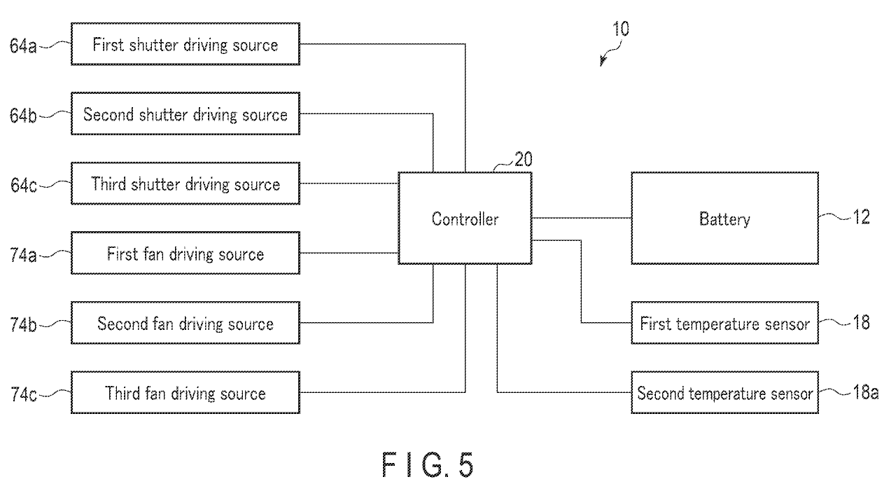

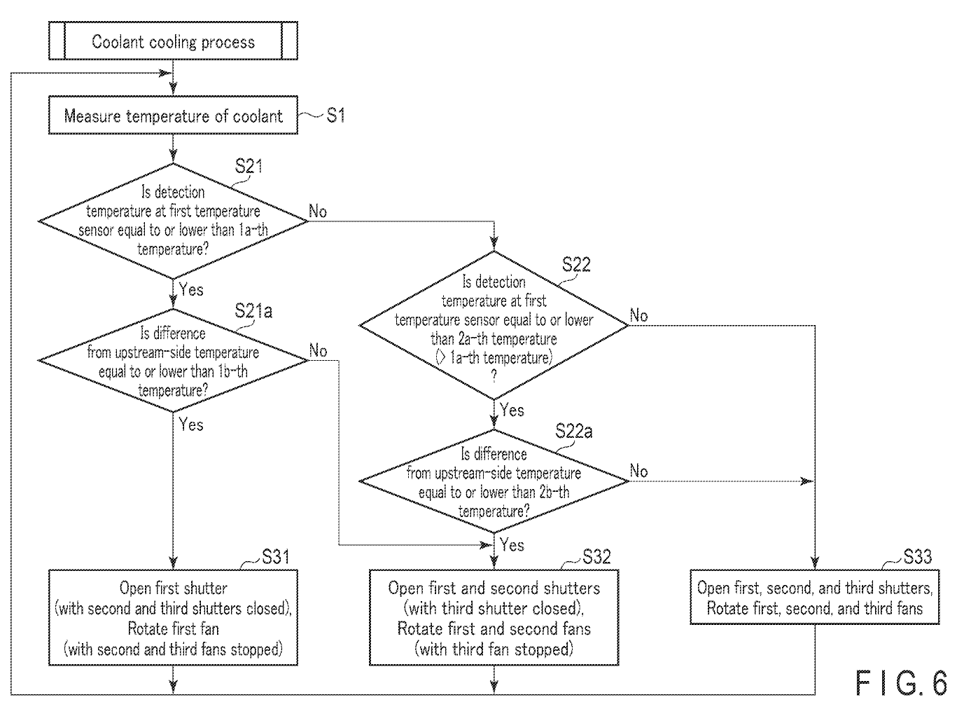

A first modification of the first embodiment will be described with reference to FIGS. 5 and 6.

FIG. 5 is a schematic block diagram related to an apparatus for cooling a heat source 12 of a vehicle 10 according to the first modification of the first embodiment. FIG. 6 is a flowchart related to a cooling process of a coolant using a cooling system 22 according to the first modification of the first embodiment.

As shown in FIG. 5, the vehicle 10 includes a first temperature sensor 18 and a second temperature sensor 18a. The first temperature sensor 18 is the same as the temperature sensor 18 described in the first embodiment. The second temperature sensor 18a is adapted to be able to detect, as a second detection temperature, a temperature of a coolant at a predetermined position on a side closer to a coolant inlet to a radiator 32. The second temperature sensor 18a is capable of detecting, for example, a temperature of the coolant in a flow path 16a on the upstream side. The second temperature sensor 18a is controlled by a controller 20.

The coolant cooling process using the radiator 32 will be described with reference to the flow shown in FIG. 6. The description of the portions that are the same as those described with reference to FIG. 4 will be suitably omitted, and only different portions will be described.

When the detection temperature at the first temperature sensor 18 is a 1a-th temperature T1a or below (step S21-Yes), the controller 20 calculates a difference in detection temperature (a temperature difference) between the first temperature sensor 18 and the second temperature sensor 18a (step S21a). When the temperature difference is a 1b-th temperature T1b or below which falls within a predetermined temperature range (step S21a-Yes), the controller 20 performs processing at step S31 (first-mode processing). Also, when the temperature difference is greater than the 1b-th temperature T1b (step S21a-No), the controller 20 performs processing at step S32 (second-mode processing).

When the detection temperature at the first temperature sensor 18 is the 2a-th temperature T2a or below (step S22-Yes), the controller 20 calculates a difference in detection temperature (a temperature difference) between the first temperature sensor 18 and the second temperature sensor 18a (step S22a). When the temperature difference is a 2b-th temperature T2b or below which falls within another predetermined temperature range (step S22a-Yes), the controller 20 performs processing at step S32 (second-mode processing). Also, when the temperature difference is greater than the 2b-th temperature T2b (step S22a-No), the controller 20 performs processing at step S33 (third-mode processing).

In the case of using the two temperature sensors 18 and 18a, the controller 20 is capable of controlling the cooling apparatus 14 in this manner, for example.

### Second Modification

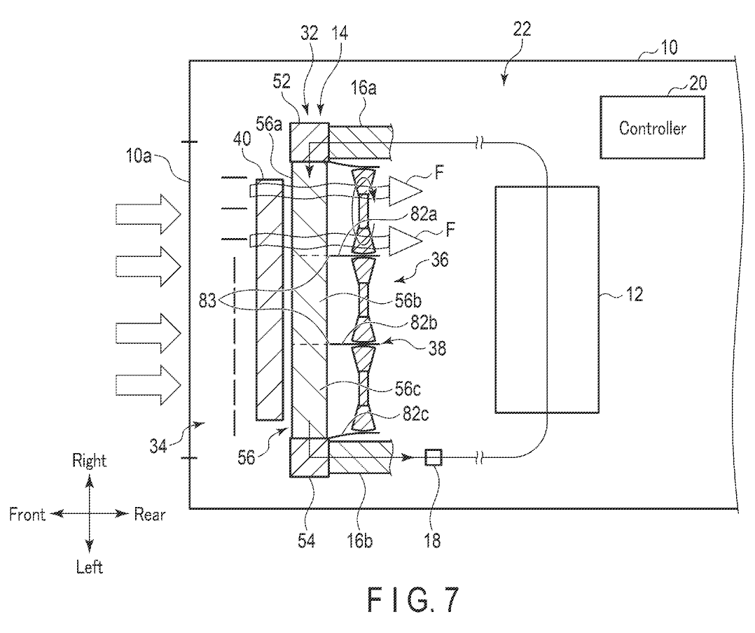

A second modification of the first embodiment will be described with reference to FIG. 7. FIG. 7 is a schematic diagram showing a part of a front section of a vehicle 10.

An example has been described in which the radiator 32 of the cooling apparatus 14 according to the first embodiment shown in FIGS. 1 and 2 is a downflow radiator with a structure of cooling a coolant by flowing the coolant from top to bottom.

A radiator 32 of the cooling apparatus 14 according to the present modification shown in FIG. 7 is a so-called crossflow radiator adapted to cool a coolant by flowing the coolant from, for example, right to left.

In this case, a first side tank is used instead of the upper tank 52 shown in FIGS. 1 and 2, and a second side tank is used instead of the lower tank 54 shown in FIGS. 1 and 2. For example, the first side tank 52 is provided at the right of the core part 56, and the second side tank 54 is provided at the left of the core part 56.

The first region (top tier) 56a, the second region (middle tier) 56b, and the third region (bottom tier) 56c described in the first embodiment respectively correspond to a right-side region, an intermediate region, and a left-side region of the core part 56 of the present modification.

The coolant cooling system 22 with the above-described structure is controlled by the controller 20, similarly to the coolant cooling system 22 described in the first embodiment. Thus, a description of the coolant cooling process will be omitted herein.

### Second Embodiment

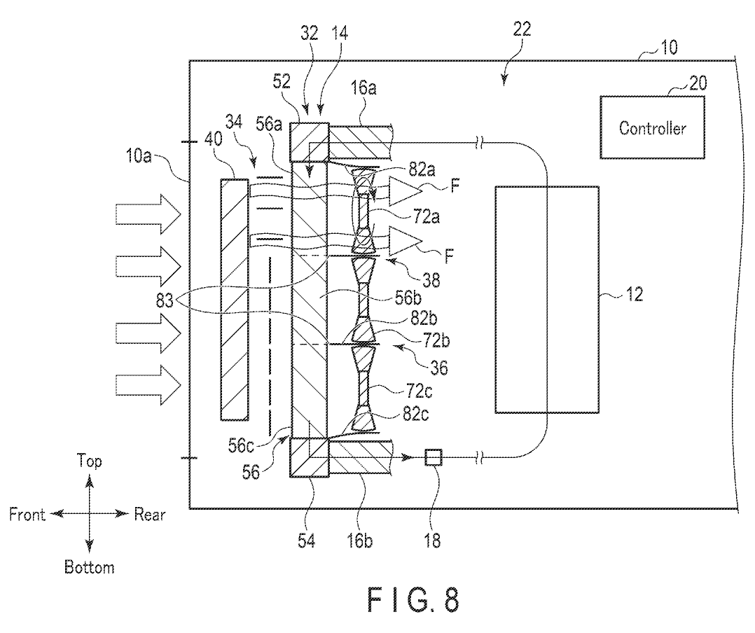

A cooling system 22 according to a second embodiment will be described with reference to FIG. 8. In the second embodiment, which is a variant of the first embodiment including its modifications, members that are the same as or members with the same functions as those described in the first embodiment will be denoted by the same reference numerals, and a description thereof will be omitted. The same applies to the embodiments that follow.

FIG. 8 is a schematic diagram showing a part of a front section of the vehicle 10 according to the second embodiment. As shown in FIG. 8, the shutter section 34 may be disposed between the condenser 40 and the radiator 32. Even with such a configuration, the cooling apparatus 14 is used in a similar manner to the cooling apparatus 14 described in the first embodiment.

### Third Embodiment

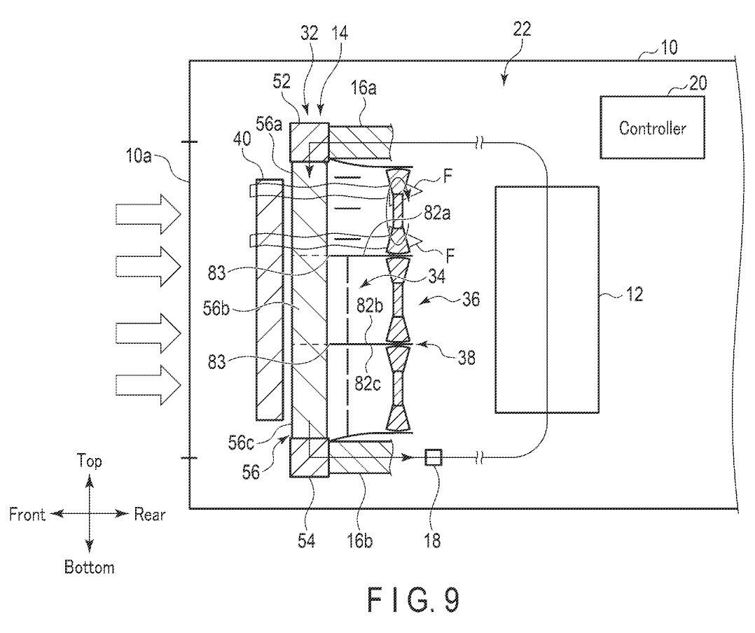

A cooling system 22 according to a third embodiment will be described with reference to FIG. 9.

FIG. 9 is a schematic diagram showing a part of a front section of the vehicle 10 according to the third embodiment. As shown in FIG. 9, the shutter section 34 may be disposed between the radiator 32 and the fan section 36. In this case, the first shutter 62a of the shutter section 34 is, for example, disposed in the first cylindrical portion 82a so as to face the top tier 56a. The second shutter 62b is, for example, disposed in the second cylindrical portion 82b so as to face the middle tier 56b. The third shutter 62c is, for example, disposed in the third cylindrical portion 82c so as to face the bottom tier 56c. Even with such a configuration, the cooling apparatus 14 is used in a similar manner to the cooling apparatus 14 described in the first embodiment.

### Fourth Embodiment

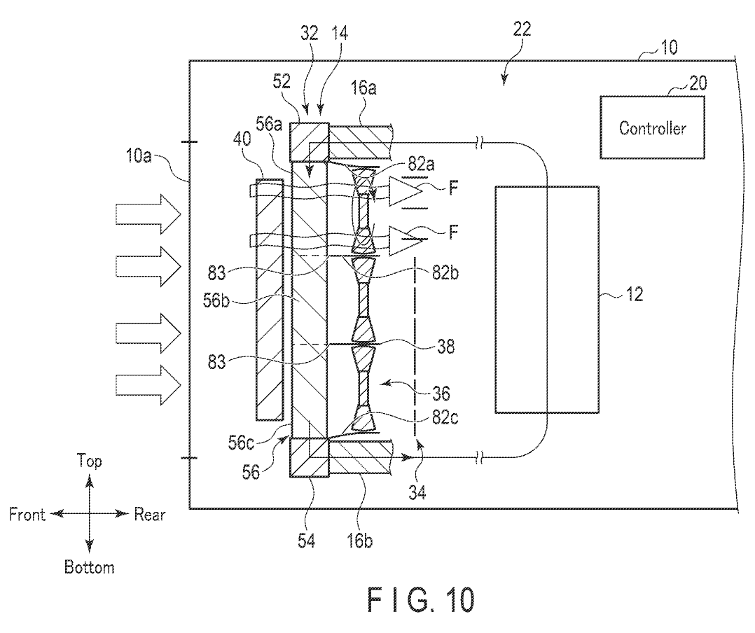

A cooling system 22 according to a fourth embodiment will be described with reference to FIG. 10.

FIG. 10 is a schematic diagram showing a part of a front section of the vehicle 10 according to the fourth embodiment. As shown in FIG. 10, the shutter section 34 is disposed at the back of a fan section 36 and a fan shroud 38.

In this case, the shutter section 34 may be, for example, disposed in the fan shroud 38 or disposed in a frame supported by a chassis. Even with such a configuration, the cooling apparatus 14 is used in a similar manner to the cooling apparatus 14 described in the first embodiment.

Accordingly, in the coolant cooling system 22, it suffices that the shutter section 34 is installed immediately before or after the radiator 32, or immediately after the fan section 36. Through the use of any of the cooling systems 22 described in the first to fourth embodiments, it is possible to make the cooling efficiency of the coolant flowing through the core part 56 of the radiator 32 favorable.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A cooling system for a coolant, comprising:
a radiator including a core part through which air is provided from a front surface side to a back surface side,
the core part being virtually partitioned into a first region and a second region along a flow direction in which a coolant is flown,
the first region being on a side closer to an upstream side and functioning as an inlet of the coolant which has passed through a heat source,
the second region being on a side closer to a downstream side than the upstream side and functioning as an outlet of the coolant;
a fan section provided on the back surface side of the core part, the fan section including a first fan facing the first region and a second fan facing the second region;
a shutter section provided on the front surface side or the back surface side of the core part, or a rear side of the fan section, the shutter section including:
a first shutter facing the first region and configured to be opened and closed for the first region,
a second shutter facing the second region and configured to be opened and closed for the second region;
a fan shroud surrounding an outer periphery of the first fan and an outer periphery of the second fan at the back surface side of the core part, and partitioning the first region and the second region at the back surface side of the core part;
a first temperature sensor configured to detect, as a first detection temperature, a temperature of the coolant at a predetermined position on a side closer to the outlet of the coolant; and
a controller configured to, based on the first detection temperature detected by the first temperature sensor, independently control the first fan and the second fan of the fan section, and independently control the first shutter and the second shutter of the shutter section,
wherein:
the controller is configured to switch between:
a first mode in which, when the first detection temperature is a first temperature or below, the controller is configured to rotate the first fan and stop rotation of the second fan in a state that the controller is configured to open the first shutter and close the second shutter; and
a second mode in which, when the first detection temperature is a second temperature or below, the second temperature being greater than the first temperature, the controller is configured to rotate the first fan and the second fan in a state that the controller is configured to open the first shutter and the second shutter.

2. The cooling system according to claim 1, wherein
the fan shroud includes:
a first cylindrical portion in a cylindrical shape surrounding the outer periphery of the first fan and extending along an outer edge of the back surface of the first region of the core part or a neighborhood thereof; and
a second cylindrical portion in a cylindrical shape surrounding the outer periphery of the second fan and extending along an outer edge of the back surface of the second region of the core part or a neighborhood thereof, to prevent an airflow to and from the first cylindrical portion at the back surface of the core part.

3. The cooling system according to claim 1, wherein
in the second mode, the controller is configured to control a rotational frequency of the first fan to be equal to or greater than a rotational frequency of the second fan.

4. The cooling system according to claim 1, further comprising:
a second temperature sensor configured to detect, as a second detection temperature, a temperature of the coolant at a predetermined position on a side closer to the inlet of the coolant to the radiator, wherein
the controller is configured to switch between:
the first mode when the first detection temperature is the first temperature or below and a difference between the first detection temperature and the second detection temperature falls within a predetermined temperature range; and
the second mode when the first detection temperature is the first temperature or below and the difference between the first detection temperature and the second detection temperature exceeds the predetermined temperature range.

5. A vehicle, comprising:
the cooling system according to claim 1;
a grille provided at a front section of the vehicle and functioning as an air intake port configured to take the air into the core part of the radiator during traveling of the vehicle; and
the heat source provided at a rear side of the cooling apparatus.
